(19) United States
(12) Patent Application Publication
(10) Pub. No.: US 2006/0279013 A1
(43) Pub. Date: Dec. 14, 2006

(54) Method and apparatus for casting a concrete product by slipform casting

(75) Inventors: Lassi Jarvinen, Valkeakoski (FI); Aimo Seppanen, Saaksmaki (FI)

Correspondence Address: BUCHANAN, INGERSOLL & ROONEY PC, POST OFFICE BOX 1404, ALEXANDRIA, VA, 22313-1404, US

(73) Assignee: Consolis Technology Oy Ab, Vantaa (FI)

(21) Appl. No.: 11/441,002

(22) Filed: May 26, 2006

(30) Foreign Application Priority Data
Jun. 8, 2005 (FI) 20050611

(51) Int. Cl. B28B 3/00

(52) U.S. Cl. 264/33; 264/333; 425/200; 425/433

(57) ABSTRACT

A method and an apparatus for casting a concrete product with a substantially horizontal slipforming process, the casting mix in said method being fed at least in two different stages to a mold proceeding with the cast, whereby at least in one casting stage the casting mix to be fed to the mold is accelerated into a desired speed before taking the mix to the casting mold.

The present invention relates to manufacturing of elongated, prestressed, solid or hollow-cored concrete products by a slipform casting process, and it also relates to a slipforming apparatus to be used for the casting. More specifically, the invention relates to feeding of concrete mix in different stages of the slipforming operation.

There are many different slipforming methods and devices known in the art. The most essential slipforming solutions in use nowadays are generally based on extruder or slipformer methods. In the solutions based on the extruder technique, the concrete mix is fed from the concrete mix tank to feed screws that extrude the concrete to the mold defined by the casting bed and the side and upper trowelling plates. When casting hollow-core slabs, the feed screws are followed by hollow-core mandrels that form the hollow-cores to the concrete product to be cast. The compacting of the concrete product to be cast is effected by the vibrating and/or leveling motion of the side and upper trowelling plates and the forming of the hollow-core is secured by the compacting motion of the hollow-core mandrel. The casting machine moves along the casting bed driven by the reacting force of the feed screws, supported by the wheels of the machine. The ready-cast product remains on the casting bed.

In the solutions based on the slipformer-technique, the concrete mix is fed with proceeding cast first to the lower part of the mold defined by the side plates moving along with the casting machine and the casting bed. With the proceeding cast, this first feed of the concrete mix is followed by vibrating shoes that by vibrating the concrete mix compact the cast concrete mix and form the hollow cores to the product for the part of the fed concrete mix. The vibrating shoes are followed by trowelling mandrels that secure the formation of the hollow cores to the product to be cast. During the second feed, concrete mix is fed onto the rest parts of the hollow-core forming mandrels for casting the upper part of the product to be cast, said concrete mix to be compacted with a vibrating pate located on top of the rear end. The ready-cast product remains on the casting bed.

The slipforming process is usually used for casting of elongated products, which are sawn to products with a suitable length after hardening of the concrete.

A problem with the devices of slipformer type known in the art is, however, how to get enough concrete mix to the central portion of the product to be cast when casting high products. The concrete mix for the lower surface can be easily fed and compacted, as well as the concrete mix for the upper surface. In a two-stage slipforming apparatus, the concrete mix for the upper surface and the central portion is fed in one stage, which is the second stage. For example between the high and narrow hollow core mandrels of a high hollow core slab, it is difficult to get enough concrete mix so as to get a homogenous and evenly compacted cross-section as a whole.

In the methods known in the art, the concrete mix is batched in two different stages from the concrete mix tank to the feeding hopper so that the surface level of the feeding hopper remains approximately constant. In some solutions, the feeding hopper also performs reciprocating movement in the longitudinal direction of the casting device, so as to improve, together with the hydrostatic pressure of the concrete mix in the hopper, the filling of the spaces between the hollow cores with the concrete mix. The casting speed must be kept slow enough, so as to ensure the filling of the spaces at least moderately.

In the solution in accordance with the present invention, the concrete mix is led from a concrete mix tank through a feeding hopper onto belt feeders, said belt feeders feeding the concrete mix to the casting mold. By means of the belt feeders, the concrete mix can be fed with a higher speed than in the traditional solutions, where the concrete mix is poured from the feeding hopper downwards between the hollow-core mandrels. In addition, in the solution in accordance with the invention, guiding plates can be used on top of the mandrels to guide a required amount of concrete mix between the mandrels. The speed of the motion of the belts can be adjusted according to the casting speed.

The belts of the belt feeder can also be adjusted in the casting apparatus so, that in connection with one feeding stage or the both of the feeding stages, there are two belt feeders placed opposite to each other. Thereby the feeding hoppers feed concrete mix to the gap formed between the belts. These feeding belts located opposite to each other can advantageously also be located so, that the mutual distance between the belts gets shorter when moving towards the feeding end of the belt feeder, where the concrete mix is fed to the mold. With this kind of a solution, pressure can be exerted to the concrete mix in the feeding stage, said pressure providing pre-compaction of the concrete mix between the belts. Also by means of the mutual speed difference of the belts, the pre-compaction of the concrete mix to be fed can be intensified.

The kinetic energy caused by the belt feeders in the concrete mix causes the compaction of the fresh concrete, when the concrete mix collides to the compacted concrete in the casting mold, cast in the first casting stage. By means of the kinetic energy, the boundary surface between the two different casting layers can be made homogenous and compact. When increasing the casting speed, the speed of the belt feeders will be correspondingly increased. The final compacting of the product to be cast is provided by means of the reciprocating movement of the hollow core mandrels and the vibrating beam.

With a solution of the present invention, a high casting speed of the casting apparatus is provided, as well as a homogenous cross section of the product to be cast. In addition, a more simple construction of the casting apparatus can be provided with the solution of the invention, because by using belt feeders for feeding the concrete mix into the mold, the concrete mix can be fed to the belt feeders directly from the concrete mix tank, whereby the feeding hoppers in the casting apparatus can be omitted.

More specifically, the method in accordance with the present invention is characterized by what is stated in the characterizing part of claim 1, and the casting apparatus in accordance with the present invention is characterized by what is stated in the characterizing part of claim 5.

The invention will be described by way of example in more detail in the following with reference to the enclosed drawings, wherein

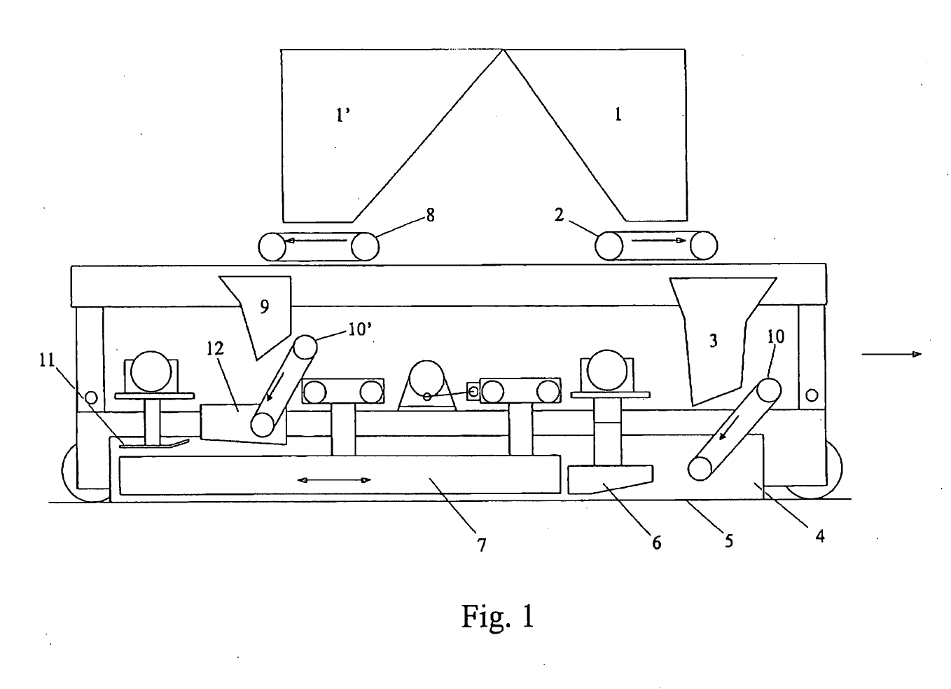

FIG. 1 is a schematic view of one slipform casting apparatus according to the first embodiment of the present invention,

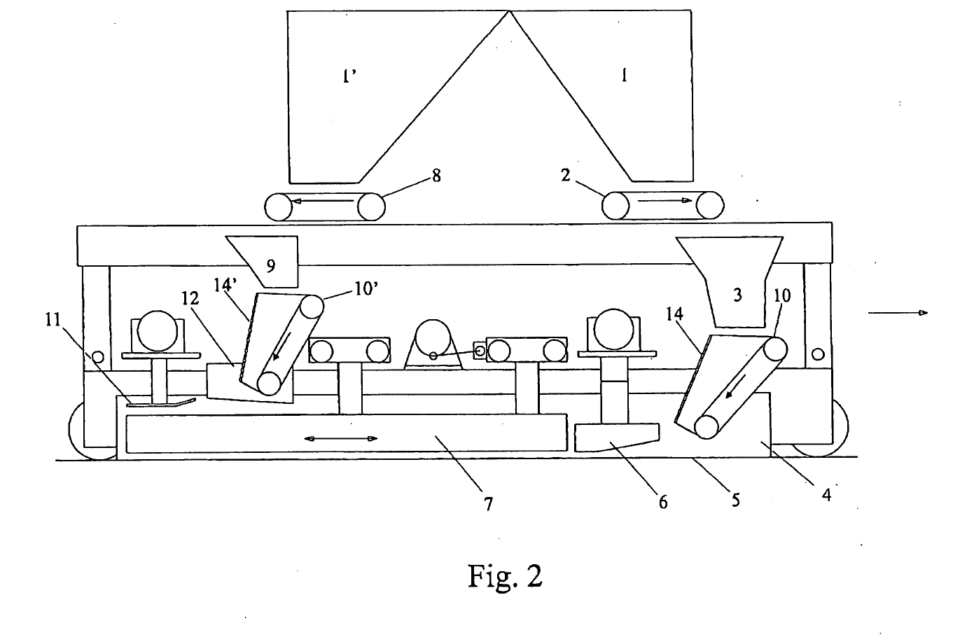

FIG. 2 is a schematic view of one slipform casting apparatus according to the second embodiment of the present invention,

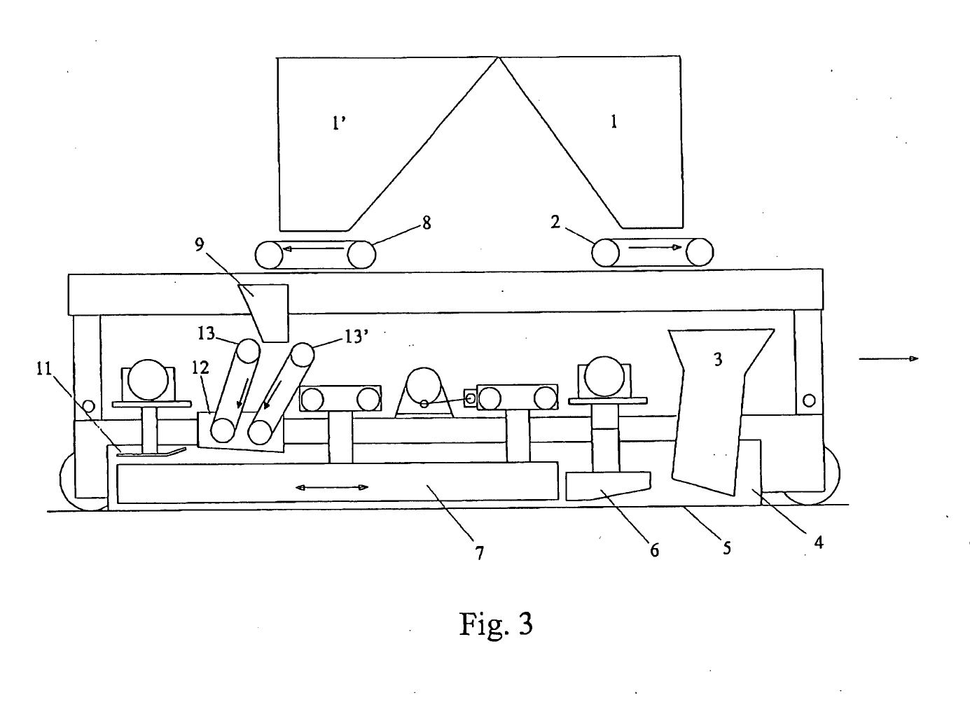

FIG. 3 is a schematic view of one slipform casting apparatus according to the third embodiment of the present invention, and

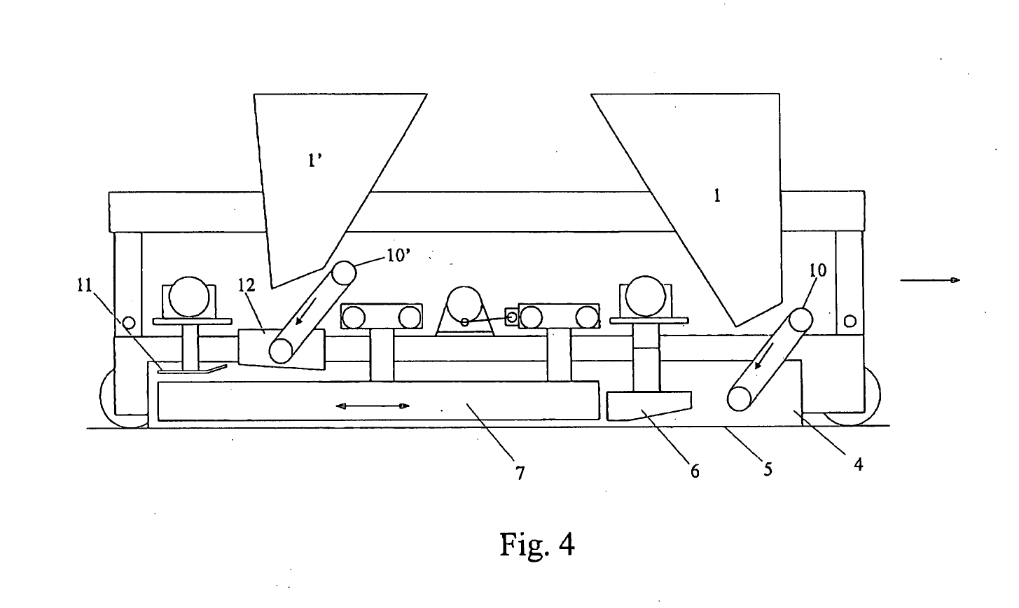

FIG. 4 is a schematic view of a simplified embodiment of the embodiment of FIG. 1.

In the apparatus in accordance with the first embodiment of the present invention, shown in FIG. 1, the concrete mix in the first casting stage is fed from the concrete mix tank 1 through the conveyor 2 to the first feeding hopper 3 feeding the concrete mix to the belt feeder 10, accelerating the speed of the concrete mix to be fed to a desired speed and feeding the concrete mix with that speed to the lower surface of the product to be cast. The amount of the concrete mix to be fed in the first casting stage is enough to fill approximately the half of the height of the casting mold formed by the side plates 4 and the casting bed 5. With the proceeding of the apparatus, the lower portions of the hollow cores are formed to the lower portion of the product to be cast by means of a vibrating shoe 6 and a trowelling mandrel 7 making reciprocating movement. In the second casting stage, the concrete mix is fed from the concrete mix tank 1′ through a conveyor 8 to second feeding hopper 9, which in turn feeds concrete mix to the belt feeder 10′ that correspondingly accelerates the concrete mix to be fed to the desired speed and feeds it to the upper portion of the product to be cast. The concrete mix fed in the second casting stage fills the gaps between the trowelling mandrels 7 in the mold and covers the upper parts of the trowelling mandrels. For guiding the concrete between the trowelling mandrels, there are guiding plates 12 located onto the trowelling mandrels. The second casting stage in the apparatus is followed by a vibrating beam 11 defining the upper surface of the product to be cast and compacting it.

In the slipform casting apparatus of the second embodiment of the present invention, shown in FIG. 2, surfaces 14, 14′ are placed above that conveyor surface of the belt feeders 10, 10′, to which the concrete mix is fed. The upper surface 14, 14′ has advantageously the same width as the belt feeder 10, 10′ and it is connected to the side edge of the conveyor with side surfaces so that the upper surface 14, 14′, the side surfaces and the belt feeder 10, 10′ define a limited cross-section, to which the concrete mix is fed by means of the feeding hoppers 3 and 9. In the example shown in the figure, the distance between the upper surface 14, 14′ and the belt feeder 10, 10′ preferably decreases towards the mold. Thereby the pressure of the concrete mix increases when it is transported towards the mold, which increases the feeding pressure of the concrete mix to the mold, thus improving the filling of the mold. In addition, the increase of the pressure on the belt feeder causes the pre-compaction of the concrete mix before it proceeds to the casting mold.

In the slipform casting apparatus of the third embodiment of the present invention, shown in FIG. 3, two belt feeders are positioned against each other in connection with the second feeding of the concrete mix in the slipform casting apparatus. In the example of the figure, the concrete mix feed of the first casting stage is effected in a traditional way known in the art, whereby the concrete mix is fed from the concrete mix tank 1 through a conveyor 2 to a feeding hopper 3, concrete mix being fed from the feeding hopper to the casting bed by means of the hydrostatic pressure caused by the concrete mix in the feeding hopper. In the second casting stage, the concrete mix is fed from the concrete mix tank 1′ through a conveyor 8 to a feeding hopper 9, from which the concrete mix is fed between the belt feeders 13, 13′. The belt feeders accelerate the speed of the concrete mix to the desired speed before feeding it to the mold, so as to make the concrete mix to penetrate well enough between the trowelling mandrels.

In the example shown in FIG. 3, the belt feeders 13, 13′ are positioned with respect to each other so that the gap between the upper ends of the feeders, to which the concrete mix is fed from the second feeding hopper 9, is bigger than the gap between the lower ends of the belt feeders, from which the concrete mix is fed to the mold, in other words, the belt feeders are angled with respect to each other. In that way a pressure for compacting the concrete mix can be advantageously provided between the belt feeders, for improving the compaction of the concrete mix in the mold.

Even though in the example of FIG. 3 the belt feeders are provided only in connection to the second casting stage, it is clear for those skilled in the art that the belt conveyors can also be provided in connection to the first casting stage.

Also a more simplified embodiment of the embodiment of FIG. 1, shown in FIG. 4, is provided according to the invention. In this simplified embodiment, the concrete mix is fed from the concrete mix tank 1, 1′ directly to the belt feeders 10, 10′. The feeding hoppers used in the traditional slipform casting apparatuses are not necessarily needed in the solution in accordance with the invention, because the speed caused by the feed conveyor to the casting mix is enough to cause a compact filling of the casting mold prior to the final compacting of the product to be cast. Thus, the feeding hoppers feeding the casting mix by means of the hydrostatic pressure of the casting mix to the mold or to the feeding conveyor as well as the elements required by those are not necessary in the casting apparatus in accordance with the invention.

Although the invention has been described in the above described examples in connection with casting of concrete mix, the invention is not limited to the use of concrete mix in the cast, but also other corresponding casting mixtures can be cast with the solution in accordance with the invention.

The belt feeder disclosed in the description of the invention can be in the simplest way implemented with a traditional belt conveyor.

1. A method for casting a concrete product with a substantially horizontal slipforming process, whereby the casting mix is fed at least in two stages to a mold moving progressively with the cast, wherein at least in one stage of the casting, the casting mix to be fed to the mold is accelerated to a desired speed, before taking the casting mix to the casting mold.

2. A method according to claim 1, wherein the casting mix to be fed to the mold is accelerated to a desired speed in each casting stage before the mix is taken to the casting mold.

3. A method according to claim 1, wherein the casting mix is compacted by means of compression in connection with the acceleration of the casting mix.

4. A method according to claim 1, wherein the acceleration of the casting mix is implemented by means of belt conveyors.

5. An apparatus for casting a concrete product with a substantially horizontal slipforming process, said apparatus comprising a mold (4, 5) proceeding with the casting process, means (1, 1′, 2, 3, 8, 9) for feeding the casting mix to the mold at least in two different casting stages and means (6, 7, 11) for compacting the casting mix, wherein the apparatus comprises means (10, 10′, 13, 13′) for accelerating the casting mix to the desired speed before taking the casting mix to the casting mold.

6. An apparatus in accordance with claim 5, wherein the apparatus comprises means (13, 13′, 14, 14′) for compacting the casting mix simultaneously with the acceleration of the casting mix to the desired speed.

7. An apparatus in accordance with claim 5, wherein the means for accelerating the casting mix to the desired speed before taking the casting mix to the casting mold comprises a belt conveyor (10, 10′).

8. An apparatus in accordance with claim 6, wherein the means for compacting the casting mix simultaneously with the acceleration of the casting mix comprises a surface (14, 14′) located above the belt conveyor (10, 10′).

9. An apparatus in accordance with claim 8, wherein the surface located above the belt conveyor (10, 10′, 13′) is a belt conveyor (13).

10. An apparatus in accordance with claim 8, wherein the belt conveyor (10, 10′, 13′) and the surface (14, 14′, 13) located above the conveyor surface thereof are connected to each other so as to form a limited cross-section.

11. An apparatus according to claim 8, wherein the distance between the belt conveyor (10, 10′, 13′) and the surface (14, 14′, 13) located above conveyor surface thereof decreases when moving in the feeding direction of the casting mix.

12. An apparatus according to claim 5, wherein the apparatus comprises guiding plates (12) for guiding the flow of the casting mix.

13. An apparatus according to claim 5, wherein the casting mix to be cast with the apparatus is concrete mix.

14. A method according to claim 2, wherein the casting mix is compacted by means of compression in connection with the acceleration of the casting mix.

15. A method according to claim 2, wherein the acceleration of the casting mix is implemented by means of belt conveyors.

16. A method according to claim 3, wherein the acceleration of the casting mix is implemented by means of belt conveyors.

17. An apparatus in accordance with claim 6, wherein the means for accelerating the casting mix to the desired speed before taking the casting mix to the casting mold comprises a belt conveyor (10, 10′).

18. An apparatus in accordance with claim 8, wherein the means for compacting the casting mix simultaneously with the acceleration of the casting mix comprises a surface (14, 14′) located above the belt conveyor (10, 10′).

19. An apparatus in accordance with claim 9, wherein the belt conveyor (10, 10′, 13′) and the surface (14, 14′, 13) located above the conveyor surface thereof are connected to each other so as to form a limited cross-section.

20. An apparatus according to claim 9, wherein the distance between the belt conveyor (10, 10′, 13′) and the surface (14, 14′, 13) located above conveyor surface thereof decreases when moving in the feeding direction of the casting mix.

21. An apparatus according to claim 10, wherein the distance between the belt conveyor (10, 10′, 13′) and the surface (14, 14′, 13) located above conveyor surface thereof decreases when moving in the feeding direction of the casting mix.
